(19) United States
(12) Patent Application Publication
(10) Pub. No.: US 2002/0118145 A1
(43) Pub. Date: Aug. 29, 2002

(54) T-pad

(76) Inventor: Tyrone James Power II, Scott, LA (US)

Correspondence Address: Tyrone J. Power II, 237 Brothers Rd, Scott, LA, 70583, US

(21) Appl. No.: 09/795,602

(22) Filed: Feb. 28, 2001

(51) Int. Cl. G09G 5/00

(52) U.S. Cl. 345/1.3

(57) ABSTRACT

The T-Pad is a computer that allows a user to physically record and view different types of information simultaneously without conflicts between information by way of two screens and with the aid of a stylus. The T-Pad's second screen/display replaces a physical keyboard however the T-Pad accommodates for a keyboard and other input and output devices. The T-Pad is only limited to ones' imagination for usage and should acknowledge by sight that the T-Pad is a creative format of computer hardware.

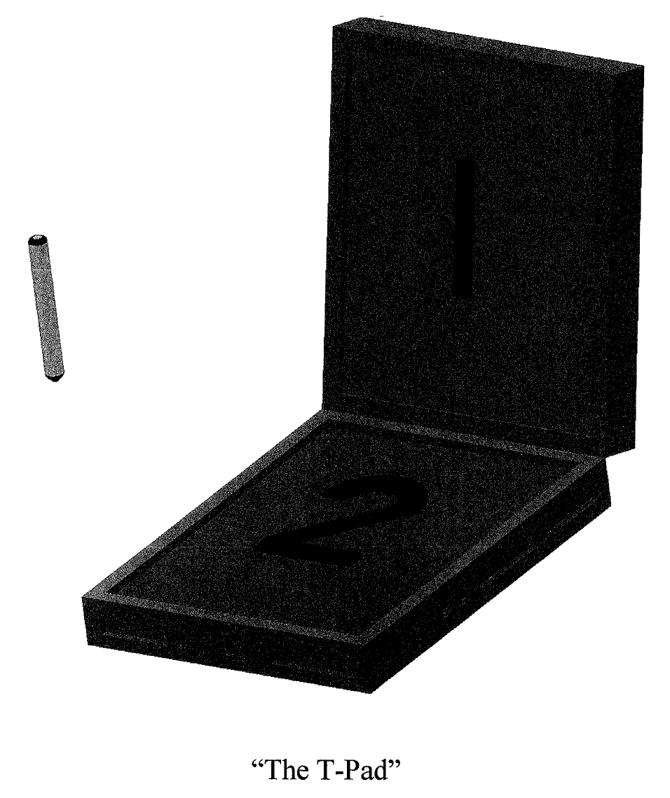

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MEICROFICHE APPENDIX

Not Applicable

### BACK GROUND OF THE INVENTION

The T-Pad remained only a concept for many years until January 2001 when the much needed, component that would allow a computer with the T-Pad characteristics to be a viable machine, appeared in a magazine article. The February 2001 edition of the magazine Popular Science contained an article that once read and was found that there will be a computer device that will be available for purchase in the year 2002. The device is a computer developed by Microsoft named Tablet PC. The Tablet PC's key component developed by Microsoft, which would complete the T-Pad as a viable product, is a newly developed screen/display.

### BRIEF SUMMARY OF THE INVENTION

I am seeking a patent for a computer, which I currently named T-Pad, that will contain two (2 screens/displays) were the addition of a second screen/display would replace the physical/mechanical keyboard. The description of such a machine could possibly for the first time eliminate the need of paper or possibly reduce the need. T-Pad would house many components and software found in computers of today and future advanced components and software. However, to validate the T-Pad concept, a computer with two screens, one or two of the screens/displays would possess write capabilities directly to the surface of the screen by use of a stylus. The T-Pad could benefit man and the environment by use in many areas of living. The initial idea of a computer with two screens/displays originated at the educational level. The T-Pad with recordable devices would replace textbooks and notebooks made of paper thus reducing the amount of weight one must carry. The user on an educational level could use such a computer by using one screen to view textbook information while using the second screen for recording information thus replacing paper.

### BRIEF DESCRIPTION OF THE SEVERAL VIEWS OF THE DRAWING

Not Applicable

### DETAILED DESCRIPTION OF THE INVENTION

The T-Pad concept will be an improvement over all known computers. Two screens/displays in one computer offering write capabilities in one housing/unit and the absence of a keyboard in that housing/unit seems original innovation. The T-Pad is depicted by one three-dimensional isometric illustration following this page. Each screens separate housing dimensions are 12.5in. ×9.5in. ×1.5in. A hinged area connects the two screen housings but it is understood as one unit but also only one potential design of hardware layout. The dimensions were chosen only to complement a standard sheet of paper, which currently seems as the most likely size for user appeal. The perimeter of the T-Pad model illustrates potential porting for attaching additional peripherals/hardware indicated with gold coloring. Exact locations of individual components and dimensions of T-Pad are not desired for a patent. The desire for a patent is a computer with two screens/displays and the absence of a physical keyboard found as a machine/unit/device. The illustration indicates the two screens/displays with numbers 1 and 2 and is colored green. The illustration depicts a representation of a stylus colored in orange.

1. What I, Tyrone J. Power II, claim as my invention is a computer that utilizes two screens/displays and would not house a physical/mechanical keyboard.
The computer contains the necessary peripherals/hardware and software/programs for accomplishing spectrums of use.
Porting accommodations are found on the computer for expanding functions.
